(19) United States
(12) Patent Application Publication
(10) Pub. No.: US 2026/0359778 A1
(43) Pub. Date: Nov. 12, 2026

(54) ADAPTIVE LOAD MATCHING SYSTEM

(71) Applicant: Private Fleet Net Zero, San Francisco, CA (US)

(72) Inventors: Russell Kennedy Jones, San Francisco, CA (US); Linda Drucker, San Francisco, CA (US)

(73) Assignee: Private Fleet Net Zero, San Francisco, CA (US)

(21) Appl. No.: 19/201,047

(22) Filed: May 7, 2025

(51) Int. Cl. G06Q 10/083; G06Q 10/0639

(52) U.S. Cl. CPC G06Q 10/08355; G06Q 10/06393

(57) ABSTRACT

The disclosure involves determining a dynamic adjustment factor based on a carrier metric (e.g., carrier characteristics) and a utilization index (e.g., route efficiency) associated with a load capacity and load demand. The carrier metric can include carrier characteristics such as a carrier size or carrier type. The utilization index may be a measure of a relationship between routes along which a load capacity is available and a load demand is received. For example, utilization index can be indicative of an unloaded distance-a distance that a vehicle has to travel before and after fulfilling the load demand request. Different carrier metrics or utilization indices result in different dynamic adjustment factors. The dynamic adjustment factor is applied to a matching coefficient to obtain an adjusted matching coefficient, which is used to assign a load demand to an available load capacity.

### TECHNICAL FIELD

The disclosure is related to data processing in the logistics industry, and more specifically, to dynamically adjusting a matching coefficient based on operational parameters for load assignment.

### BACKGROUND

In the realm of transportation logistics, private fleets are often established by a manufacturer, distributor or a retailer with distribution facilities, each establishing a fleet of vehicles, as the private fleet, to meet their internal transportation needs. The private fleet hauls the load from an origin location to a destination location and then usually returns to the origin location empty, inherently wasting transportation resources. The private fleet often provides transportation services on the open market, especially in the backhaul (return trip) capacity to haul a load, which not only helps the private fleet to increase profits but also provides a substantial decarbonization of the environment.

Efficient load matching between available load capacities and load demands (e.g., in backhaul) is crucial for optimizing resource utilization and minimizing transportation costs. Traditional methods have relied heavily on manual processes and static data, which often result in suboptimal load matching and underutilization of transportation resources. In traditional methods, freight carriers and shippers rely on static pricing models and manual negotiations to allocate load capacity, leading to inefficiencies such as underutilized fleet capacity, increased deadhead miles, and suboptimal route planning. These inefficiencies result in higher operational costs, increased fuel consumption, and negative environmental impacts.

Existing load-matching systems fail to dynamically utilize factors such as fleet size, fleet type, route efficiency, and load demand fluctuations to adjust capacity allocation. Current solutions lack a systematic approach to integrating carrier-specific attributes (e.g., scale of operations) with the route efficiency attributes (e.g., deadhead miles), resulting in suboptimal routing decisions that fail to reduce empty miles and improve load utilization.

### SUMMARY

The disclosed embodiments are directed to dynamically optimizing load assignments in a transportation network. A load assignment metric represents a computational value associated with fulfilling a load demand (e.g., cost). A matching coefficient, which serves as a predefined adjustment applied to the load assignment metric, is dynamically modified based on operational factors. A dynamic adjustment factor is computed based on the operational parameters such as a carrier metric (e.g., carrier characteristics) and a utilization index (e.g., route efficiency) associated with a load capacity and load demand. The dynamic adjustment factor is used to adjust the matching coefficient in order to enable optimized allocation of load demand to an available load capacity of a carrier. The adjusted matching coefficient is then applied to the load assignment metric for assigning the load demand to the available load capacity. By dynamically adapting the matching coefficient, certain embodiments optimize transport resource allocation, enhance fleet utilization, and reduce deadhead miles.

A load matching system receives data packets indicating available capacities along various routes (“load-capacity routes”) and demand along different routes (“load-demand routes”). When a capacity matches a demand, the system determines a dynamic adjustment factor based on one or more operational parameters, such as a carrier metric or utilization index.

The system may derive the dynamic adjustment factor from a carrier metric, such as:
Size: indicative of fleet volume or number of vehicles in a fleet. Larger fleets may have lower dynamic adjustment factors. For example, a first-size carrier may have a “20%” dynamic adjustment factor, a second-size carrier (larger) may have “10%,” a third-size carrier “0%,” and a fourth-size carrier “−3%.”
Type: indicative of deployment structure (e.g., for-hire, private, dedicated fleet, etc.). Different types may have varying dynamic adjustment factors.

The matching coefficient, which represents a preset adjustment value to be applied to a load assignment metric, based on which the load-demand is assigned to the load-capacity for causing a vehicle to fulfill a load demand, is modified by the dynamic adjustment factor. For instance, if the matching coefficient is “10%” and the dynamic adjustment factor is “10%,” the adjusted matching coefficient becomes “20%,” or “0.2” (adjusted matching coefficient=matching coefficient+dynamic adjustment factor) meaning a shipper or broker would expect a “20%” reduction on an actual load assignment metric (e.g., shipping cost) to assign the load demand to the carrier. Conversely, a negative dynamic adjustment factor decreases the matching coefficient. If the matching coefficient is “10%” and the dynamic adjustment factor is “−3%,” the adjusted matching coefficient becomes “7%” or “0.07.”

Similarly, different carrier types may correspond to different dynamic adjustment factors.

The load matching system may determine the dynamic adjustment factor based on a utilization index, which measures the relationship between a load-capacity route and a load-demand route. One example involves unloaded distance (e.g., deadhead miles) the distance a vehicle must travel empty before and after fulfilling a load-demand. The load matching system derives this distance from load-capacity and load-demand data packets and assigns dynamic adjustment factors accordingly. For instance, if an unloaded distance falls within:
A first range, the dynamic adjustment factor may be “0%.”
A second (greater) range, the dynamic adjustment factor may be “−1%.”
A third (greater) range, “−2%,” and so on.
   As with carrier metrics, the matching coefficient is adjusted based on the dynamic adjustment factor.

Alternatively, the utilization index may be based on time taken to travel the unloaded distance. The adjustment factor varies based on travel time of the unloaded distance, with longer travel times typically resulting in lower dynamic adjustment factors.

The load matching system may determine the dynamic adjustment factor using a weighted set of parameters, such as carrier metrics and utilization index, assigning different weights to different parameters.

Once the dynamic adjustment factor is determined and applied to the matching coefficient, the adjusted matching coefficient is sent to a transportation service system for acceptance/approval or rejection by the carrier. If accepted, the load matching system generates a match notification for the carrier and the requesting entity (e.g., a shipper or broker) for assigning the load demand to the load capacity.

By dynamically adjusting the matching coefficient based on operational parameters such as fleet size, fleet type, or route efficiency, the load matching system increases the likelihood of matching load demand with better/the best available capacity. This increased likelihood of matching not only enhances revenue opportunities, but also improves fleet utilization, and reduces unnecessary resource consumption (e.g., vehicle fuel) from travelling unloaded distances, thereby lowering emissions and supporting environmental sustainability (e.g., by environmental decarbonization).

Various other aspects, features, and advantages of the inventions will be apparent through the detailed description of the invention and the drawings attached hereto. It is also to be understood that both the foregoing general description and the following detailed description are exemplary and not restrictive of the scope of the inventions. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates an environment in which the disclosed embodiments may be implemented, consistent with various embodiments.

FIG. 2A is a block diagram for determination of a matching coefficient using a dynamic adjustment factor, consistent with various embodiments.

FIG. 2B is a flow diagram of a method for determining the matching coefficient using a dynamic adjustment factor, consistent with various embodiments.

FIG. 3 is a block diagram for determination of the matching coefficient using a dynamic adjustment factor, consistent with various embodiments.

FIG. 4 is a flow diagram of a method for assigning a load demand to available load capacity based on a dynamically adjusted matching coefficient, consistent with various embodiments.

FIG. 5 is a block diagram of a computer system as may be used to implement features of the disclosed embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

In the following description, for the purposes of explanation, numerous specific details are set forth in order to provide a thorough understanding of the embodiments of the invention. It will be appreciated, however, by those having skill in the art that the disclosed embodiments may be practiced without these specific details or with an equivalent arrangement. In other cases, well-known structures and devices are shown in block diagram form in order to avoid unnecessarily obscuring the disclosed embodiments.

The following describes some terminologies in logistics or transportation services industry. A “shipper” may be anyone who requests transportation services from a transportation services provider (TSP). The shipper may be the entity providing goods needing transport. In the alternative, the shipper may be a party receiving goods, and/or just an entity that is arranging transportation services of the goods. For purposes of this disclosure, “shipper” is intended to mean anyone who commissions transportation services. If specific categories of transportation are specified, the meaning of “shipper” would be limited as required by the categories.

A transportation service provider or TSP is a business entity that provides transportation (e.g., ground transportation). In some cases, the TSP is an independent driver (owner-operator) or similar, whereas in other cases, the TSP performs most of the contract functions in arranging for loads and scheduling. For purposes of the present disclosure and the claims, unless otherwise specified, TSPs comprise companies, mobile operators (MOs) and drivers, as well as independent drivers, with the terms used interchangeably. A TSP may also be referred to as a carrier.

Typical shipping is accomplished by directly engaging a transport company, such as a package delivery service, shipping by private fleet controlled by the shipper, brokering services and other transport arrangements. In many cases, the transport is performed on a bid basis, using TSPs such as common carrier haulers.

A freight broker or broker is a third-party intermediary that connects shippers (who need to transport goods) with carriers (truck drivers or trucking companies that have available capacity). Typically, the broker does not own any trucks or transport the goods themselves. Instead, they use their expertise and network to match the right carrier with the right load, often negotiating rates and optimizing routes.

Private fleets are often established by a manufacturer, distributor or a retailer with distribution facilities, to meet their own transportation needs. Regardless, private fleets may provide transportation services on the open market, especially with their backhaul (return trip) capacity.

A for-hire fleet is a transportation fleet operated by a third-party carrier that moves goods for external customers in exchange for payment. Unlike private fleets, which are owned and operated by companies to transport their own products, for-hire fleets provide transportation services to multiple clients. The for-hire fleets typically charge based on distance, weight, or service time and play a crucial role in logistics by enabling flexible and scalable freight movement. These for-hire fleet companies while they own and maintain their fleet, they do not own the cargo they move; they simply provide transportation services to shippers, retailers, or other businesses.

A for-hire fleet, or subset of trucks, assigned exclusively to one client under a contract may be referred to as a “dedicated” fleet.

Non-limiting examples of transportation services are shipments of loads and related trucking services. Transportation services can include moving passengers, taxi, car services, and so-called “ride sharing” services in which a central business arranges rides for fares, in which case the load can be a passenger or packages. In each of these cases, the transportation service has at least one origin or destination. While “shipper,” “consignor,” “consignee,” “load,” “hauler” and “shipment” are described in connection with transportation services, the descriptions are given by way of non-limiting examples. Transportation services also include providing transportation for items other than loads, so that the “shipper” and “load” may be a passenger or other entity submitting the transportation request, and a “shipment” may be the passenger's trip provided as a transportation service.

In many cases, TSPs use “shipping lanes”, which are origin-destination (consignor-consignee) pairs, generally identified by the general geographical areas of the origin and destination rather than the specific location of the origin or destination. Nevertheless, the “shipping lane” may vary in its specificity, depending on many factors. For example, if a long-distance haul is performed, the TSP may be willing to extend the definition of the shipping lane to cover larger geographic areas for the origin and destination to have an easier time to find a return (backhaul) load. To use a specific non-limiting example, if a TSP is providing services between New York and San Francisco, an origin or destination in Philadelphia may be within the scope of the shipping lane, but over a shorter distance, Philadelphia may be a significant diversion from a shipping lane whose terminus is New York. Various such criteria may be used to determine whether a location (e.g., geographical area) is within the scope of a specified shipping lane. Note that a shipping lane may also be referred to as “lane,” “shipping path,” “path,” “shipping route”, or “route” and these terms may be used interchangeably.

A “backhaul” may be a return leg in a simple two leg departure-and-return trip. Some trips include more than two legs, in which case a “next leg” or “subsequent leg” generally connects a series of legs back to the origin. Such trips with more than one “backhaul” leg can be more profitable, in that there is often an imbalance of transportation needs in both directions of a shipping lane but are more complicated to arrange because they involve additional arrangements for transportation services and because it is not always apparent how to optimize transportation services bookings. In origin and destination (consignor and consignee) oriented transportation services, it is anticipated that an initial trip will have a subsequent leg. In the case of a simple two-way trip, the single subsequent leg or next leg is a “backhaul”. A “deadhead” leg is a leg without a load, but also describes the connection between different termini while empty or not delivering a load.

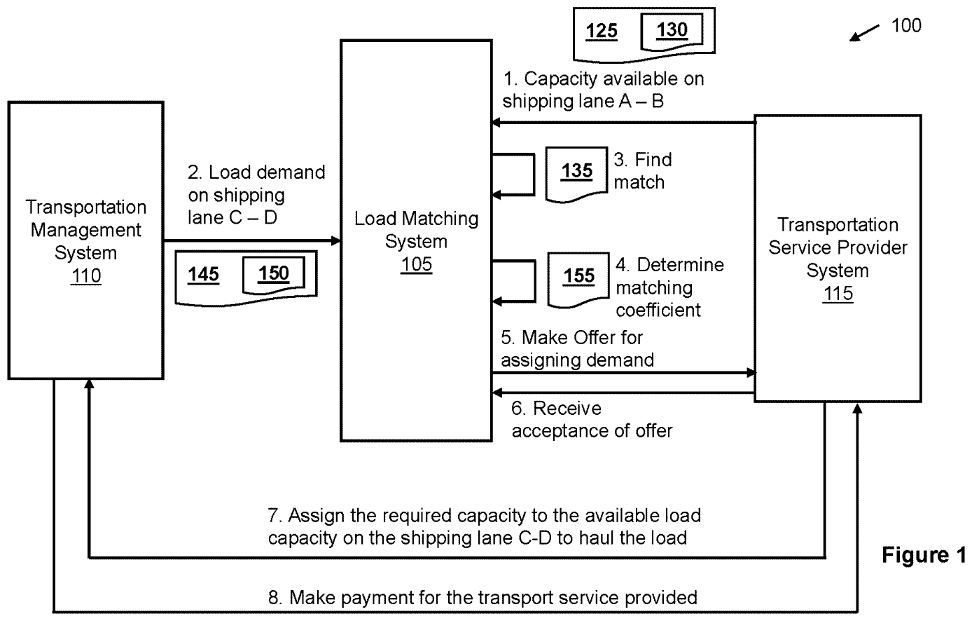

FIG. 1 illustrates an environment 100 in which the disclosed embodiments may be implemented, consistent with various embodiments. Environment 100 includes transportation service provider (TSP) system 115, which receives load-capacity data packet indicating available load capacity, carrier characteristics, or other transportation services from a TSP.

The load-capacity data packet may include various details, such as load-capacity route (also referred to as load-capacity lane) with an origin location and a destination location between which the load capacity is available. The location information of origin and destination locations can be provided in varying degrees of specificity, including state, city, portion of a city, zip code, etc. Additional details may include the date and time when load capacity is available, vehicle type, type of load that can be hauled, TSP identification information (generated by TSP system 115 in some embodiments), or other transportation service attributes.

The load capacity data may be submitted through various channels. For example, the load capacity data may be provided via electronic mail (e-mail), web user interface, mobile communication device app such as a smartphone app, short message service (SMS), voice message, interactive voice response (IVR), telephone communications not using IVR and other suitable interfaces. The TSP system 115 includes a parsing component that extracts attributes such as origin location and destination location of the load-capacity data packet.

The load capacity data may be stored in a storage system associated with TSP system 115 in a predefined format (e.g., as predefined fields and values). In some embodiments, TSP system 115 converts the received load capacity data into the predefined format prior to storing the load capacity data, while in others, both the original and predefined formats are stored. The TSP system 115 may be associated with one or more TSPs, allowing one or multiple TSPs to input their load capacity availability into TSP system 115.

Environment 100 includes transportation management system 110, which receives load demand requests from entities such as shippers or brokers. A load demand request may contain various details, such as a load-demand route (also referred to as load-demand lane) with an origin location and a destination location between which the load capacity is required by the load-demand requesting entity. Additional information may the date and time when the load capacity is needed, vehicle type required, a type of load that needs to be hauled, shipper identification information, or other relevant transportation service attributes.

Similar to the load capacity data, the load demand data may be submitted through various channels. For example, the load demand data may be submitted via e-mail, web user interface, mobile communication device app such as a smartphone app, SMS, voice message, IVR, telephone communications not using IVR and other suitable interfaces. The transportation management system 110 includes a parsing component that extracts attributes such as origin location and destination location of the load-demand lane where the load capacity is needed.

The transportation management system 110 may store the load demand data in a storage system in a predefined format. In some embodiments, transportation management system 110 converts the received load demand request into the predefined format prior to storage, while in others, both the original and predefined formats are stored. The transportation management system 110 may be associated with one or more load-demand requesting entities, allowing multiple load-demand requesting entities to input their load demand into transportation management system 110.

The transportation management system 110 and TSP system 115 may be implemented on shared hardware or as separate independent hardware systems. In some embodiments, transportation management system 110 and TSP system 115 operate as fully independent systems.

The environment 100 includes load matching system 105, which matches a load demand request with an available load capacity. The load matching system 105 communicates with both transportation management system 110 and TSP system 115 to facilitate the matching. FIG. 1 includes an illustrative example sequence of interactions between these three entities.

In a first interaction, load matching system 105 receives load-capacity data packet 125 from TSP system 115. As mentioned above, load-capacity data packet 125 may include details of a shipping lane or load-capacity lane 130 where transportation services (e.g., load capacity) are available from the TSP. For example, load-capacity data packet 125 may specify origin location and destination location of load-capacity lane 130 as “Location A” and “Location B,” respectively.

In a second interaction, load matching system 105 may receive load-demand data packet 145 from transportation management system 110. The load-demand data packet 145 may include details of a shipping lane or load-demand lane 150, such as an origin location and a destination location where the load capacity is required by load-demand requesting entity. For example, load-demand data packet 145 may specify origin location and destination location of the load-demand lane 150 as “Location C” and “Location D,” respectively.

Multiple load-capacity data packets and load-demand packets received from various carriers and requesting entities, respectively, may be stored in the storage system. The load matching system 105 may have access to these load-capacity data packets and load-demand data packets.

In a third interaction, load matching system 105 may find a matching lane 135 to assign a load demand to an available load capacity. The match may be determined in several ways. For example, load matching system 105 may compare a load-demand lane, such as load-demand lane 150, with various load-capacity lanes to identify a match. In some embodiments, a load-capacity lane is identified as a matching lane 135 if its origin location and destination location match those of the load-demand lane. In some embodiments, a load-capacity lane is considered as a match if origin location and destination location of the load-demand lane is within a specified radius or travel time of the origin and destination locations, respectively, of the load-capacity lane. In the example of FIG. 1, load-capacity lane 130 is determined as matching lane 135. The lane matching process is not limited to these examples and may include other methods as well.

In some embodiments, multiple matching lanes may be identified. These lanes may be ranked based on user-defined criteria, such as deadhead miles, additional travel time, fuel consumption, etc. incurred for fulfilling the load-demand request, carrier type, carrier size, or other parameters.

Note that, in some embodiments, identifying a matching lane may not be the sole criterion for assigning a load demand to an available load capacity. Additional factors may be considered, including transportation equipment, transportation capabilities and business practices of a TSP providing the transportation services, type of transportation service offered or needed, preference data of the TSP and the shipper, expected service price, shipper budget for the service, etc.

In some embodiments, if multiple load demands exist (e.g., load demand from multiple shippers) for a specified lane, load matching system 105 may be configured to receive and process bids from the shippers awarding available capacity to a winning bid (e.g., highest bid). Conversely, if multiple load capacities are available for a load demand request, load matching system 105 may process bids from the TSPs, assigning the load demand request to a winning bid (e.g., lowest bid).

In some embodiments, load matching system 105 may be implemented using a prediction model, such as a machine learning (ML) model, which is trained to match load demand requests with available load capacity. The prediction model may consider various factors, such as ML model inferred factors (e.g., user preference data), which may not be explicitly provided but inferred by the prediction model (e.g., during training or during inference stage) in matching a load demand request with available load capacity. Other prediction models, such as statistical models or other analytics models, may be used in lieu of or in addition to ML models.

In a fourth interaction, load matching system 105 determines matching coefficient 155 to assign a load demand to the available load capacity on matching lane 135. In some embodiments, matching coefficient 155 is an adjustment applied to a load assignment metric when assigning a load demand to an available load capacity of a carrier. For example, matching coefficient 155 may be applied on a load assignment metric such as an expected cost of shipping a load across load-demand lane 150 to adjust the load assignment metric. The load matching system 105 assigns the load demand based on whether matching coefficient 155 meets specific criteria. For example, the load demand may be assigned to the TSP associated with load-capacity data packet 125 if TSP system 115 determines that the matching coefficient 155 is within an allowed coefficient range, or if the TSP explicitly approves the matching coefficient 155. By approving matching coefficient 155, a TSP may indicate acceptance of the adjusted load assignment metric for assigning the load demand to their load capacity.

In some embodiments, a preset matching coefficient undergoes adjustment using a dynamic adjustment factor, which is determined based on one or more operational parameters, such as a carrier metric (e.g., carrier characteristics) or a utilization index (e.g., route efficiency) associated with the load demand and the matched load capacity.

The load matching system 105 may derive the dynamic adjustment factor from any of a carrier metric, such as (a) a size, which is indicative of fleet volume of the carrier, (b) a type, which is indicative of a deployment structure of the carrier (e.g., for-hire fleet, private fleet, dedicated fleet, etc.), (c) one or more past performance metrics (e.g., delivery punctuality score, safety performance index etc.), or (d) an engagement metric (e.g., volume of business) associated with the load-demand requesting entity. In some embodiments, load matching system 105 retrieves the carrier metric from load-capacity data packet 125. The dynamic adjustment factor may have different values for different carrier size categorizations or different carrier types. In some embodiments, larger fleets may have lower dynamic adjustment factors, that is, a greater carrier size results in lower dynamic adjustment factor.

The load matching system 105 may determine the dynamic adjustment factor based on a utilization index, which measures the relationship between load-capacity lane 130 and load-demand lane 150. For example, load matching system 105 may determine the utilization index based on unloaded distance (deadhead miles)-the distance a vehicle must travel empty before and after fulfilling the load-demand. The load matching system 105 derives this distance based on lane information obtained from load-capacity data packet 125 and load-demand data packet 145 and determines the dynamic adjustment factors accordingly. The dynamic adjustment factor may have different values for different unloaded distances. In some embodiments, larger unloaded distances may have lower dynamic adjustment factors, that is, a greater unloaded distance results in lower dynamic adjustment factor. In another example, the utilization index may be based on time taken to travel the unloaded distance. The dynamic adjustment factor varies based on travel time of the unloaded distance, with longer travel times typically resulting in lower dynamic adjustment factors.

The load matching system 105 may determine the dynamic adjustment factor based on one or more performance metrics. A performance metric may be determined based on one or more measurement parameters. For example, a performance metric may include a delivery punctuality score, which is determined based on a deviation between actual and scheduled delivery timestamps. In some embodiments, a higher delivery punctuality score—indicating greater punctuality by a carrier —corresponds to lower dynamic adjustment factor. In another example, the performance metric may include a load acceptance ratio, representing the percentage of load requests accepted by the carrier. In some embodiments, a higher load acceptance ratio results in a lower dynamic adjustment factor. In yet another example, the performance metric may include a damage-free delivery rate, defined as the percentage of shipments delivered without damage. In some embodiments, higher damage-free delivery rates may result in lower dynamic adjustment factors.

In still another example, the performance metric may include a responsiveness metric, which is indicative of a temporal response pattern of the carrier to load-matching events. Examples of responsiveness metric include one or more of a load offer response time, estimated time of arrival (ETA) update latency, bid response frequency, etc. The load offer response time may be indicative of a time between load offer sent and carrier's response. In some embodiments, higher load offer response time may result in higher dynamic adjustment factors. The ETA update latency may be indicative of time delay in providing an updated ETA to the load-demand requesting entity. In some embodiments, higher ETA update latency may result in higher dynamic adjustment factors. The bid response frequency may be indicative of ratio of offered bids to accepted/rejected ones within a timeframe. In some embodiments, higher bid response frequency may result in lower dynamic adjustment factors.

In still another example, the performance metric may include a safety performance index of a carrier entity, which reflects historical compliance with transport safety regulations, incident rates, and inspection outcomes. The safety performance index may be derived from safety compliance data, incident history, and regulatory performance records. For example, the safety performance index may be based on one or more of (a) regulatory safety scores (e.g., Federal Motor Carrier Safety Administration's (FMCSA) compliance, safety and accountability (CSA) scores in the U.S.); (b) accident incident rate, indicating the number of reported accidents per mile or shipment of the carrier; (c) inspection pass/fail ratio, reflecting outcome of carrier's vehicle inspections; (d) violation history, indicating past safety violations (e.g., hours of service, maintenance); (e) driver safety index, which is a composite score for driver behavior linked to that carrier, or other such parameters. In some embodiments, higher safety performance index may result in lower dynamic adjustment factors. In some embodiments, the data for determining the safety performance index may be obtained from at least one of TSP system 115 or from a third-party source, such as FMCSA systems.

The load matching system 105 may also determine the dynamic adjustment factor based on an engagement metric, which is indicative of a degree of engagement between the carrier entity and a load-demand requesting entity (e.g., shipper or broker). For example, the engagement metric may be computed based on how frequently the load-requesting entity engages the carrier entity, or the volume of business the carrier entity receives from the load-requesting entity. In some embodiments, a higher engagement metric results in higher dynamic adjustment factors.

The load matching system 105 may determine the dynamic adjustment factor using a weighted combination of parameters, such as carrier metrics, utilization index, performance metric, engagement metric or other parameters, assigning different weights to different parameters.

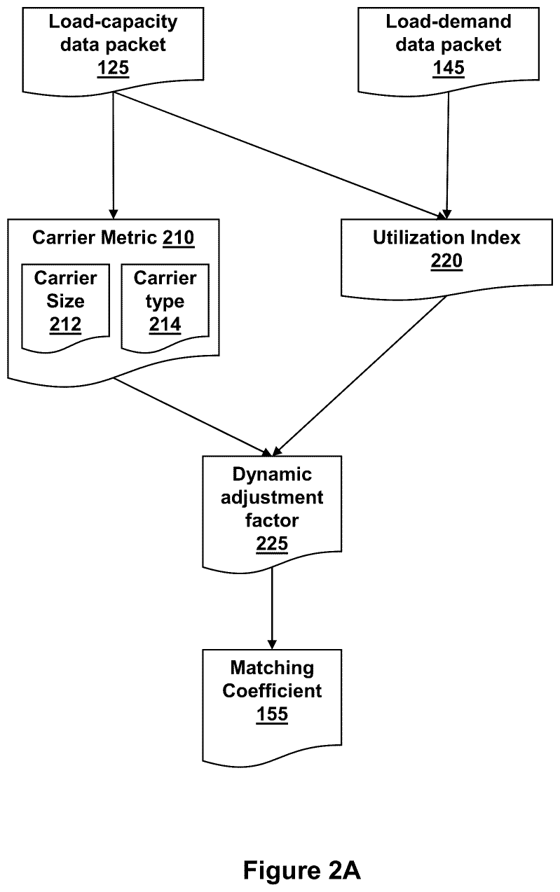

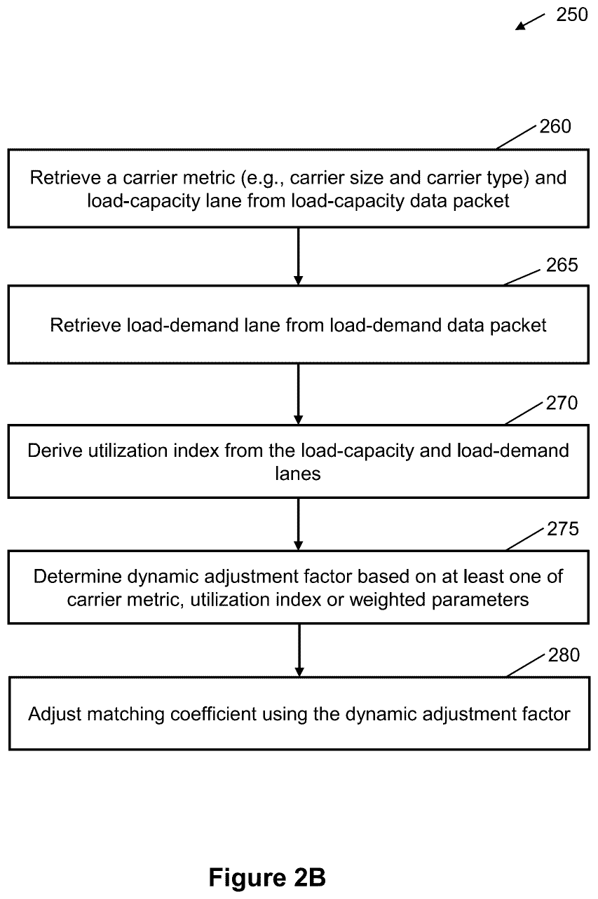

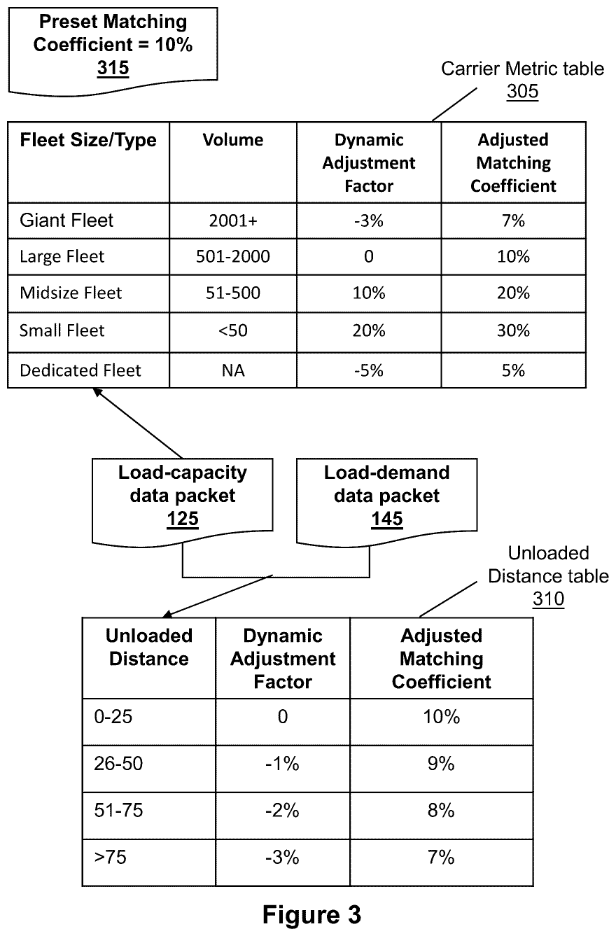

After the dynamic adjustment factor is determined, load matching system 105 applies the dynamic adjustment factor to the preset matching coefficient to obtain adjusted matching coefficient 155. Additional details of determining the dynamic adjustment factor are described at least with reference to FIGS. 2A-2B and 3 below.

In a fifth interaction, load matching system 105 transmits the adjusted matching coefficient 155 to TSP system 115 for acceptance/approval or rejection by the carrier associated with load-capacity data packet 125.

In a sixth interaction, load matching system 105 receives a response data packet, indicating an acceptance, rejection, or a revision (e.g., counteroffer) of the adjusted matching coefficient 155. The sixth interaction may continue between the carrier entity and the load-demand requesting entity until either matching coefficient 155 is (a) rejected, preventing the load-demand from being assigned to the available load capacity, or (b) accepted, allowing load matching system 105 to proceed with assigning the load demand to the available load capacity.

In a seventh interaction, upon receiving an acceptance of matching coefficient 155, load matching system 105 generates a match notification, formally assigning the load demand associated with load-demand data packet 145 to load capacity associated with load-capacity data packet 125, for provisioning of the transportation service to the load-demand requesting entity along load-demand lane 150. In some embodiments, load matching system 105 sends a notification having the load capacity data to transportation management system 110, which may further forward the notification to a shipper or broker associated with the load-demand data packet 145. Similarly, load matching system 105 sends a notification having the load demand data to TSP system 115, which may further forward the notification to a TSP associated with load-capacity data packet 125.

In an eighth interaction, transportation management system 110 and TSP system 115 are configured to facilitate the payment from the load-demand requesting entity to the TSP for providing the transportation services (e.g., hauling the load). In some embodiments, the payment may be determined based on adjusted matching coefficient 155 applied to the load assignment metric.

Note that this sequence of interactions represents just one possible implementation of matching a load demand to an available load capacity based on matching coefficient. The process may include additional, fewer, or alternative interactions. Some steps may execute sequentially, in parallel, simultaneously, synchronously, or asynchronously. For example, while FIG. 1 illustrates sequential receipt of load-capacity data packet 125 followed by load-demand data packet 145, these interactions may occur independently, in reverse order, or asynchronously. The load matching system 105 stores both data packets and performs the matching process once both are available.

Additionally, in some embodiments, users may input data such as load-capacity data packet 125 or load-demand data packet 145 directly into load matching system 105, bypassing TSP system 115 or transportation management system 110. For example, the load capacity data may be input to the load matching system (e.g., by a TSP) via e-mail, web user interface, mobile communication device app such as a smartphone app, SMS, voice message, IVR, telephone communications not using IVR and other suitable interfaces. The load matching system 105 may include a parsing component that extracts the required attributes, such as the origin and destination locations of load-capacity lane 130 or load-demand lane 150.

FIG. 2A is a block diagram illustrating the determination of a matching coefficient using a dynamic adjustment factor, consistent with various embodiments. FIG. 2B is a flow diagram of a method 250 for determining the matching coefficient using a dynamic adjustment factor, consistent with various embodiments. The method 250 may be implemented within environment 100 (e.g., using load matching system 105).

The load matching system 105 receives (a) load-capacity data packets indicating available load capacities along specific lanes (“load-capacity lanes”) and (b) load-demand data packets indicating load demands along specific lanes (“load-demand lanes”). When a load demand along a particular load-demand lane (e.g., load-demand lane 150 from load-demand data packet 145) matches with an available load-capacity along a particular load-capacity lane (e.g., load-capacity lane 130 from load-capacity data packet 125), load matching system 105 determines a dynamic adjustment factor 225 based on one or more operational parameters, such as a carrier metric 210 or a utilization index 220.

At block 260, load matching system 105 retrieves carrier metric 210 from load-capacity data packet 125. The carrier metric 210 may include one or more carrier characteristics such as (a) a size 212, which is indicative of fleet volume of the carrier, or (b) a type 214, which is indicative of a deployment structure of the carrier (e.g., for-hire fleet, private fleet, dedicated fleet, etc.). The load matching system 105 may also retrieve load-capacity lane 130 from load-capacity data packet 125.

At block 265, load matching system 105 retrieves load-demand lane 150 from load-demand data packet 145.

At block 270, load matching system 105 derives utilization index 220, which measures a relationship between load-demand lane 150 and load-capacity lane 130. One example of the utilization index 220 includes unloaded distance (deadhead miles)-the distance that a vehicle has to travel to before and after fulfilling the load demand with an empty load. In some embodiments, load matching system 105 derives the unloaded distance based on load-capacity lane 130 and load-demand lane 150. The unloaded distance may be derived as a sum total of the distance between (a) origin locations of load-capacity lane 130 and load-demand lane 150, and (b) destination locations of load-demand lane 150 and load-capacity lane 130.

Another example of utilization index 220 includes a time taken to travel the unloaded distance. In some embodiments, load matching system 105 may determine the time taken to travel the unloaded distance as the time taken to travel the distance between (a) origin locations of load-capacity lane 130 and load-demand lane 150, and (b) destination locations of load-demand lane 150 and load-capacity lane 130.

At block 275, load matching system 105 determines dynamic adjustment factor 225 based on one or more of carrier metric 210, utilization index 220, other parameters including for-hire market metrics, or a weighted combination of the parameters. As a first example, load matching system 105 may derive dynamic adjustment factor 225 from carrier metric 210. The dynamic adjustment factor 225 may have different values for different carrier size categorizations or different carrier types. FIG. 3 is a block diagram illustrating potential matching coefficients and dynamic adjustment factors for various carrier metrics or utilization indices, consistent with various embodiments. As illustrated in carrier metric table 305, in some embodiments, larger fleets may have lower dynamic adjustment factor, that is, a greater carrier size results in lower dynamic adjustment factor. For example, for a first-size carrier (e.g., “Small fleet” having less than 50 vehicles), dynamic adjustment factor 225 may be “20%,” for a greater second-size carrier (“Midsize fleet” having 51-500) “10%,” for a greater third-size carrier (“Large fleet” having 501-200) “0%,” for a greater fourth-size carrier (“Giant fleet” having 2001 or more vehicles) “−3% ”. The carrier size 212 may be retrieved from load-capacity data packet 125. For example, if the carrier size 212 retrieved from load-capacity data packet 125 indicates that the carrier is a midsize fleet, load matching system 105 determines the dynamic adjustment factor 225 as “10%.”

Similarly, different carrier types may correspond to different dynamic adjustment factors. As illustrated in carrier metric table 305, in some embodiments, for a carrier type of “dedicated fleet,” dynamic adjustment factor 225 may be “−5%.” Similarly, for a private fleet, dynamic adjustment factor 225 may be “5%” and for-hire fleet may be “10%.”

As a second example, load matching system 105 may determine dynamic adjustment factor 225 based on utilization index 220, which measures a relationship between a load-capacity lane and a load-demand lane. As described above, one example of utilization index 220 includes unloaded distance (deadhead miles)—the distance that a vehicle has to travel to before and after fulfilling the load demand. The dynamic adjustment factor 225 may have different values for different unloaded distances. As shown in unloaded distance table 310, in some embodiments, larger unloaded distances may have lower dynamic adjustment factor 225, that is, a greater unloaded distance results in lower dynamic adjustment factor 225. For example, if an unloaded distance falls within (a) a first range (e.g., 0-25 miles), dynamic adjustment factor 225 may be “0%,” (b) a second greater range (e.g., 26-50), dynamic adjustment factor 225 may be “−1%,” (c) a third greater range (e.g., 51-75), dynamic adjustment factor 225 may be “−2%” and so on.

In some embodiments, utilization index 220 may be based on a time taken to travel the unloaded distance. The dynamic adjustment factor 225 may have different values for different times taken to travel the unloaded distances. In some embodiments, longer travel times typically result in lower dynamic adjustment factors, that is, a greater time taken to travel the unloaded distance results in lower dynamic adjustment factor. Note that the values indicated in the tables of FIG. 3 are for illustrative purposes only and the values can be different for embodiments. Further, the values can also be input or modified by the load-requesting entity.

As a third example, load matching system 105 determines dynamic adjustment factor 225 using a set of weighted parameters. In some embodiments, load matching system 105 assigns different weights to different parameters such as the carrier metric, the utilization index, or any other parameter, and determines dynamic adjustment factor 225 based on the set of weighted parameters. For example, load matching system 105 may associate weights w_{CS}, w_{CT}, w_{UID}, w_{UIT}, w_{PM} and, w_{EM} with carrier size (CS), carrier type (CT), utilization index distance-based (UID) and utilization index time-based (UIT), performance metric (PM) and engagement metric (EM) parameters, respectively, and determines dynamic adjustment factor 225 based on the weighted set of parameters. For example, dynamic adjustment factor 225 (DAF) may be expressed as:

DAF=CS_{w}_{_{CS}}+CT_{w}_{_{CT}}+UID_{w}_{_{UID}}+UIT_{w}_{_{UIT}}+PM_{w}_{_{PM}}+EM_{w}_{_{EM}} Equation (1)

Although Equation 1 illustrates six parameters, DAF may be computed using any subset of these parameters or additional parameters. Furthermore, any of these parameters may include multiple sub-parameters. For example, the performance metric may include one or more sub-parameters such as delivery punctuality score, load acceptance ratio, damage-free delivery rate or similar metrics, and DAF may be derived from the weighted values of these sub-parameters.

At block 280, load matching system 105 determines matching coefficient 155 based on dynamic adjustment factor 225. As described earlier, matching coefficient 155 serves an adjustment applied to a load assignment metric, which represents a computational value (e.g., cost) associated with fulfilling a load demand. The matching coefficient 155 starts with a preset reference value 315 (e.g., “10%” “0.1”) and is adjusted using dynamic adjustment factor 225 determined in block 275. For example, if matching coefficient 155 is set to “10%” and dynamic adjustment factor 225 is determined as “10%,” the adjusted matching coefficient 155 becomes “20%” or “0.2” (e.g., adjusted matching coefficient 155=dynamic adjustment factor 225+preset matching coefficient 315). This means the load-demand requesting entity (e.g., shipper or a broker) would expect a “20%” reduction on an actual load assignment metric (e.g., cost of shipping the load along the load-demand lane) to assign the load demand to the carrier. Conversely, a negative dynamic adjustment factor 225 decreases matching coefficient 155. For example, if preset matching coefficient 315 is “10%,” and dynamic adjustment factor 225 for a particular carrier size is “−3%”, the adjusted matching coefficient 155 decreases to “7%” or “0.07.”

Note that the order of steps in FIG. 2B represents just one possible sequence, and there can be more, less, or other steps or another sequence in in determining dynamic adjustment factor 225. Further, note that at least some of the steps may be executed sequentially, parallelly, simultaneously, synchronously or asynchronously. For example, while the carrier metric 210 and determining utilization index 220 are retrieved sequentially in FIG. 2B, these two steps may be independent of each other and may be executed in any order or asynchronously. Further, in some embodiments, if dynamic adjustment factor 225 is determined based on a specified parameter only, then the steps for determining the other operational parameters may not be executed. For example, if dynamic adjustment factor 225 is determined based solely on carrier metric, then the steps related to the utilization index may not be executed.

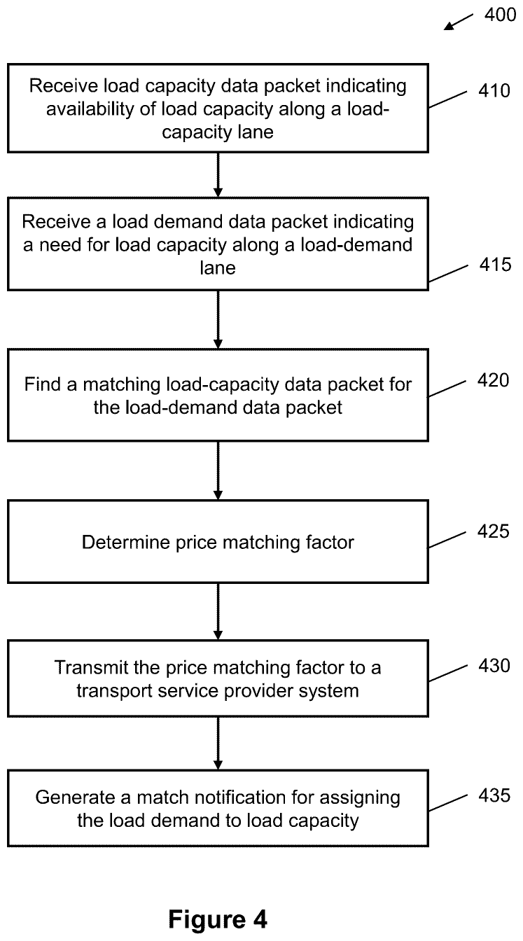

FIG. 4 is a flow diagram of a method 400 for assigning a load demand to available load capacity based on dynamically adjusted matching coefficient, consistent with various embodiments. In some embodiments, method 400 is implemented within environment 100 of FIG. 1 using load matching system 105. At block 410, load matching system 105 obtains load-capacity data packet 125, which indicates available load capacity along load-capacity lane 130. The load-capacity data packet 125 may be associated with a TSP who provides transportation services, such as hauling a load, along load-capacity lane 130.

The load matching system 105 may obtain load-capacity data packet 125 from a TSP system 115 or from a storage system associated with load matching system 105. The TSP system 115 may store load-capacity data packets associated with multiple TSPs and may be configured to publish this data to load matching system 105. The load-capacity lane 130 is identified using an origin-destination location pair. For example, the load-capacity data packet 125 indicates available load capacity in load-capacity lane 130 having origin location “Location A” and destination location “Location B.”

At block 415, load matching system 105 obtains load-demand data packet 145, which indicates a need for load capacity along load-demand lane 150. The load matching system 105 may obtain load-demand data packet 145 from transportation management system 110 or from a storage system associated with load matching system 105. The transportation management system 110 may store load-demand data packets associated with multiple load-demand requesting entities (e.g., shippers or brokers) and may be configured to publish this data to load matching system 105. The load-demand lane 150 is identified using an origin-destination location pair. For example, the load-demand data packet 145 indicates need for load capacity in load-demand lane 150 having origin location “Location C” and destination location “Location D.”

At block 420, load matching system 105 may find a matching load-capacity data packet for a load-demand data packet to assign a load demand to an available load capacity. The match may be determined in various ways. For example, load matching system 105 may compare a load-demand lane, such as load-demand lane 150, with various load-capacity lanes to identify a load-capacity lane as matching lane 135. As described earlier, in some embodiments, any load-capacity lane having matching origin and destination locations with the origin and destination locations, respectively, of the load-demand lane may be determined as matching lane 135.

In some embodiments, a load-capacity lane may be determined as matching lane 135 if the origin and destination locations of the load-demand lane is within a specified radius of the origin and destination locations, respectively, of the load-capacity lane.

Note that, in some embodiments, identifying a matching lane may not be the only criterion for matching a load demand to an available load capacity; various other criteria may be considered to determine a match. In some embodiments, a load demand is matched to available load capacity in accordance with capabilities and business practices of a TSP providing the transportation services, type of transportation service offered or needed, preference data of the TSP and the shipper, expected price for providing the service, price the shipper is willing to pay for the service, etc. In some embodiments, if there are multiple load demands (e.g., load demand from multiple shippers) for a specified lane, the load matching system 105 may be configured to receive and process bids from the shippers and a winning bid (e.g., highest bid) may be assigned the available capacity. In some embodiments, if there are multiple load capacities available for a load demand in a requested lane, load matching system 105 may be configured to receive and process bids from the TSP and a winning bid (e.g., lowest bid) may be assigned to the load demand request. Various such criteria may be used in determining a matching lane for assigning a load demand to a load capacity.

In some embodiments, multiple matching lanes may be found and the lanes may be ranked based on user-defined criteria (e.g., based on deadhead miles, additional travel time, fuel consumption, etc. incurred for fulfilling the load-demand request, carrier type, carrier size or other parameters).

At block 425, upon finding a matching load-capacity data packet and load-demand data packet (e.g., load-capacity data packet 125 and load-demand data packet 145), load matching system 105 determines a matching coefficient 155. As described earlier, a matching coefficient serves as an adjustment applied to a load assignment metric (e.g., actual or expected cost of shipping), to facilitate assignment of a load demand to an available load capacity associated with matched data packets identified in block 420.

In some embodiments, matching coefficient 155 is adjusted based on one or more operational parameters such as a carrier metric (e.g., carrier characteristics) or a utilization index (e.g., route efficiency) associated with a load capacity and load demand. For example, dynamic adjustment factor 225 is derived from one or more parameters, including a carrier metric 210 (such as a carrier size 212 or carrier type 214), utilization index 220, or a weighted set of parameters. The dynamic adjustment factor 225 is then applied to a preset matching coefficient 315 to obtain an adjusted matching coefficient 155. Additional details regarding the determination of matching coefficient are described at least with reference to FIGS. 2A, 2B and 3 above.

At block 430, once adjusted matching coefficient 155 is determined, load matching system 105 transmits adjusted matching coefficient 155 to TSP system 115 for further processing. Upon receiving the adjusted matching coefficient, TSP system 115 generates a response data packet that indicates whether the carrier accepts, rejects or proposes a counter offer with a further adjusted matching coefficient 155. The interaction in this block 430 may continue between the carrier entity and the load-demand requesting entity until matching coefficient 155 is (a) rejected, preventing the load-demand from being assigned to the available load capacity, or (b) accepted, allowing load matching system 105 to proceed with assigning the load demand to the available load capacity. In some embodiments, TSP system 115 may automatically accept the adjusted matching coefficient 155 if the adjusted matching coefficient 155 is within an allowed range.

At block 435, if the response data packet indicates an acceptance of matching coefficient 155, load matching system 105 generates a match notification to formally assign the load demand associated with load-demand data packet 145 to the load capacity associated with load-capacity data packet 125. The notification is sent to TSP system 115 for notifying a carrier associated with load-capacity data packet 125, and to transport management system 110 for notifying a load-demand requesting entity (e.g., a shipper or broker) associated with the load-demand data packet 145 that the load demand has been successfully assigned to the available load capacity.

In some embodiments, load matching system 105 may indicate a time period associated with a favorable temporal optimization indicator, which is a time-dependent load assignment metric (e.g., time-based shipping cost). The load matching system 105 may evaluate a temporal optimization indicator across a set of candidate time periods (e.g., hours in a day, days in a week, days in a year, months in a year or any other time period) and generate scheduling recommendations for the time period with most favorable temporal optimization indicator. In some embodiments, the temporal optimization indicator is based on at least one of carrier availability index, demand density index, route alignment efficiency, traffic condition index, or historical load assignment metrics index. In some embodiments, the carrier availability index reflects the availability of carriers during a time period (e.g., a week) and may be determined based number of active carriers accepting loads per day or over any other time period. Carrier availability varies over a time period and can influence the load assignment metric; typically, higher carrier availability leads to lower load assignment metric.

Load demand also fluctuates over time. In some embodiments, higher load demand correlates with a higher load assignment metric. The demand density index represents demand patterns during a specific time period and may be determined based on number of load-demand requests for a given route and/or time period (e.g., per day over a week).

The route alignment efficiency reflects the average unloaded distances traveled during a time period. Certain days may offer better lane matching than other days, resulting in shorter unloaded distances and thus a lower load assignment metric. The route alignment efficiency may be determined based on average unloaded distances for similar routes over time (e.g., per day over a week).

The traffic condition index indicates typical traffic patterns or delays during a time period. For example, Fridays or long weekends typically may experience more congestion, leading to greater delivery delays and a higher load assignment metric. The traffic condition index may be derived from average delivery time deviations or transit delays over a time period (e.g., per day over a week).

Historical load assignment metrics may also affect the load assignment metric for a specific time period. For example, load matching system 105 may analyze trends in past shipment assignments to detect variations in the load assignment metric by day or lane. The historical load assignment metric index may be computed as an average load assignment metric over a time period (e.g., per day over a week).

After evaluating the temporal optimization indicators across candidate time periods (e.g., several days of a week), load matching system 105 may generate a scheduling recommendation for the time period associated with a favorable temporal optimization indicator. For example, load matching system 105 may identify a day of the week the load assignment metric is likely to be favorable (e.g., lowest) and notify the load-demand requesting entity to schedule hauling of the load on the identified day.

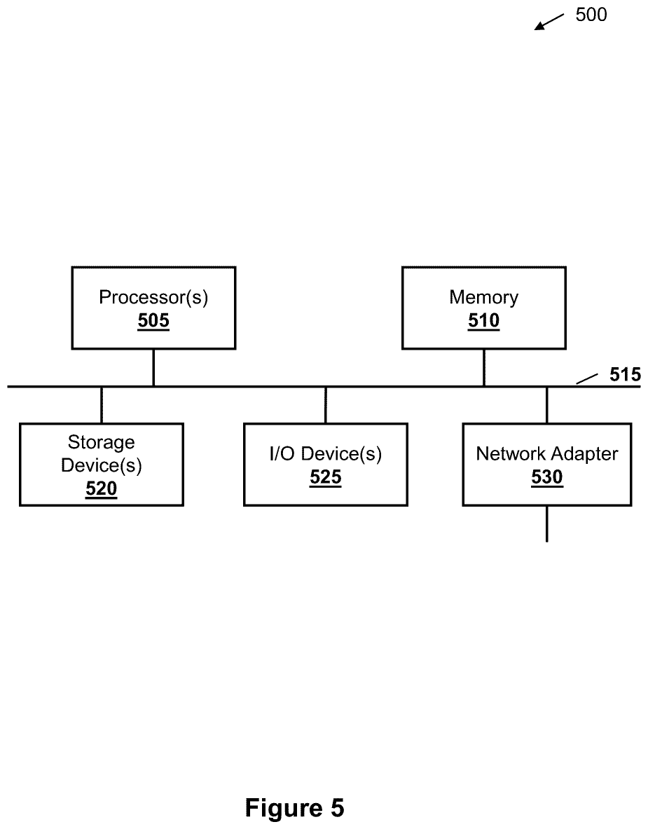

FIG. 5 is a block diagram of a computer system as may be used to implement features of the disclosed embodiments. The computer system 500 may be used to implement any of the entities, systems, subsystems, components or services depicted in the examples of the foregoing figures (and any other components described in this specification). The computer system 500 may include one or more central processing units (“processors”) 505, memory 510, input/output devices 525 (e.g., keyboard and pointing devices, display devices), storage devices 520 (e.g., disk drives, solid state drives), and network adapters 530 (e.g., network interfaces such as Ethernet or wireless interfaces) that are connected to an interconnect 515. The interconnect 515 is illustrated as an abstraction that represents any one or more separate physical buses, point to point connections, or both connected by appropriate bridges, adapters, or controllers. The interconnect 515, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Components (IEEE) standard 1394 bus, also called “Firewire” or Electronic Data Interchange (EDI), Application Programming Interface (API) or other commonly used computer to computer communication protocols. Additionally, the interconnect 515 may include interconnect technologies such as Compute Express Link (CXL), NVIDIA NVLink, AMD Infinity Fabric, Intel Ultra Path Interconnect (UPI), Cache Coherent Interconnect for Accelerators (CCIX), Gen-Z fabric, Thunderbolt 4, and optical interconnects based on silicon photonics. These advanced interconnects support high-throughput, low-latency communication across heterogeneous components including CPUs, GPUs, FPGAs, memory devices, and accelerators, enabling improved performance for data-intensive and latency-sensitive applications. The computer system 500 may also be cloud-based virtual computers.

The memory 510 and storage devices 520 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non-transitory” media) and computer-readable transmission media. The storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionality as described herein.

The instructions stored in memory 510 can be implemented as software and/or firmware to program the processor(s) 505 to carry out actions described above. The processors may be programmed to execute computer program instructions by software; hardware; firmware; some combination of software, hardware, or firmware; and/or other mechanisms for configuring processing capabilities on the processors. In some embodiments, such software or firmware may be initially provided to the computer system 500 by downloading from a remote system through the computer system 500 (e.g., via network adapter 530). The systems, such as the load matching system 105, transportation management system 110 and TSP system 115 may be implemented using computer system 500. For example, the computer systems may be implemented by a cloud of computing platforms operating together. The computer systems may enable the exchange of information within a network (e.g., via network adapter 530) or other computing platforms via wired or wireless techniques (e.g., Ethernet, fiber optics, coaxial cable, Wi-Fi, Bluetooth, near field communication, or other technologies).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICS, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

1. A method comprising:
receiving, at a load matching system:
a backhaul load-capacity data packet indicating availability of load capacity in a load-capacity route, and
a load-demand data packet indicating a need for load capacity along a load-demand route;
determining, by the load matching system, a dynamic adjustment factor based on a carrier metric and a utilization index, wherein the carrier metric is indicative of a size of a carrier entity associated with the load-capacity data packet and the utilization index is indicative of a relationship between the load-capacity route and the load-demand route;
using a prediction model generated through machine learning (ML) trained to match a load demand request and available backhaul load capacity, wherein the prediction model considers inferred factors selected from one or more of.
carrier preference data explicitly provided by the carrier entity.
carrier preference data inferred from carrier history in matching a load demand request and available backhaul load capacity, and
statistical models or other analytics models:
incorporating into the load matching system inferred factor criteria comprising one or more of carrier preference data, factors inferred by the prediction model:
finding a matching lane to assign a load demand to an available load capacity of the carrier entity, based on the carrier preference data:
determining matching coefficient for assigning a load demand to the available load capacity on the matching lane:
adjusting, by the load matching system, a matching coefficient associated with the load-demand data packet based on the dynamic adjustment factor to generate an adjusted matching coefficient, wherein the matching coefficient modifies a load assignment metric, the load assignment metric being a computed value that determines whether the load-demand data packet is assigned to the load-capacity data packet to fulfill a load demand associated with the load-demand data packet;
transmitting, by the load matching system, the adjusted matching coefficient to a transport service system; and
generating, by the load matching system and upon receiving a response data packet from the transport service system that is indicative of an acceptance of the adjusted matching coefficient by the carrier entity, a match notification for assigning the load-demand data packet to the load-capacity data packet.

2. The method of claim 1, wherein the dynamic adjustment factor has different values for different carrier metrics.

3. The method of claim 1, wherein the dynamic adjustment factor increases as the carrier metric decreases.

4. The method of claim 1, wherein determining the dynamic adjustment factor includes:
determining the dynamic adjustment factor as a zero value for the carrier metric indicative of a specified size of the carrier entity.

5. The method of claim 1, wherein determining the dynamic adjustment factor includes:
determining the dynamic adjustment factor based on a carrier type parameter associated with the load-capacity data packet.

6. The method of claim 1, wherein determining the dynamic adjustment factor includes:
determining the utilization index as an unloaded distance to be traveled by a vehicle for fulfilling the load demand, wherein the unloaded distance is determined based on the load-capacity route and the load-demand route, and
determining the dynamic adjustment factor based on the utilization index.

7. The method of claim 6, wherein the unloaded distance is determined based on a sum total of the distance between (a) an origin location of the load-capacity route and an origin location of the load-demand route, and (b) a destination location of the load-demand route and a destination location of the load-capacity route.

8. The method of claim 6, wherein the dynamic adjustment factor has different values for different utilization indices.

9. The method of claim 6, wherein the dynamic adjustment factor decreases as the unloaded distance increases.

10. The method of claim 1, wherein determining the dynamic adjustment factor includes:
determining the utilization index as time taken to travel an unloaded distance for fulfilling the load demand, wherein the unloaded distance is determined based on the load-capacity route and the load-demand route, and
determining the dynamic adjustment factor based on the utilization index.

11. The method of claim 10, wherein the time taken to travel the unloaded distance is determined based on a sum total of the time taken to travel from (a) an origin location of the load-capacity route to an origin location of the load-demand route, and from (b) a destination location of the load-demand route to a destination location of the load-capacity route.

12. The method of claim 10, wherein the dynamic adjustment factor decreases as the time taken to travel the unloaded distance increases.

13. The method of claim 1, wherein determining the dynamic adjustment factor further includes:
determining the dynamic adjustment factor based on-the a performance metric based on a performance metric associated with the carrier entity, wherein the performance metric is derived using one or more measurement parameters.

14. The method of claim 13, wherein the performance metric includes a delivery punctuality score, which is indicative of a deviation between actual and scheduled delivery timestamps.

15. The method of claim 13, wherein the performance metric includes a responsiveness metric, which is indicative of a temporal response pattern of the carrier entity to load-matching events.

16. The method of claim 13, wherein the performance metric includes a safety performance index, which is derived from safety compliance data, incident history, and regulatory performance records.

17. The method of claim 1, wherein determining the dynamic adjustment factor further includes:
determining the dynamic adjustment factor based on an engagement metric indicative of a degree of engagement between the carrier entity and a load-demand requesting entity.

18. The method of claim 1, wherein determining the dynamic adjustment factor includes:
associating a weight to each of the carrier metric, the utilization index, a carrier type parameter associated with the load-capacity data packet to generate a set of weighted parameters, and
determining the dynamic adjustment factor based on the set of weighted parameters.

19. The method of claim 1, wherein adjusting the matching coefficient includes:
adding the dynamic adjustment factor to the matching coefficient to obtain the adjusted matching coefficient.

20. The method of claim 1, wherein the receiving further includes:
comparing, by the load matching system, the load-demand route with a plurality of load-capacity routes received at the load matching system to determine a matching load-capacity route, and
determining, by the load matching system, the dynamic adjustment factor from the load-capacity data packet with which the matching load-capacity route is associated.

21. The method of claim 1, wherein generating the match notification includes:
sending the match notification to the transport service system from which the load-capacity data packet is received and to a transportation management system from which the load-demand packet is received for assigning the load-demand data packet to the load-capacity data packet.

22. The method of claim 1 further comprising:
determining, by the load matching system, a temporal optimization indicator for a set of candidate time periods; and
generating a scheduling recommendation indicative of a time period associated with a favorable temporal optimization indicator.

23. The method of claim 22, wherein the temporal optimization indicator is based on at least one of carrier availability, demand density index, route alignment efficiency, traffic condition index or historical load assignment metric index.

24. A non-transitory computer-readable storage medium for storing computer-readable instructions that, when executed by a computer, cause the computer to perform a method, the method comprising:
receiving, at a load matching system, a load-capacity data packet indicating availability of backhaul load capacity in a load-capacity route, and a load-demand data packet indicating a need for load capacity along a load-demand route;
determining, by the load matching system, a dynamic adjustment factor based on a set of weighted parameters, wherein the set of weighted parameters includes (a) a carrier metric associated with a first weight and indicative of a size of a carrier entity associated with the load-capacity data packet, and (b) a utilization index associated with a second weight and indicative of a relationship between the load-capacity route and the load-demand route; using a prediction model generated through machine learning (ML) trained to match a load demand request and available backhaul load capacity, wherein the prediction model considers inferred factors selected from one or more of.
carrier preference data explicitly provided by the carrier entity,
carrier preference data inferred from carrier history in matching a load demand request and available backhaul load capacity, and
statistical models or other analytics models:
incorporating into the load matching system inferred factor criteria comprising one of more of carrier preference data, factors inferred by the prediction model.
finding a matching lane to assign a load demand to an available load capacity of the carrier entity, based on the carrier preference data:
determining matching coefficient for assigning a load demand to the available load capacity on the matching lane;
adjusting a matching coefficient associated with the load-demand data packet based on the dynamic adjustment factor to generate an adjusted matching coefficient, wherein the matching coefficient modifies a load assignment metric, the load assignment metric being a computed value that determines whether the load-demand data packet is assigned to the load-capacity data packet to fulfill a load demand associated with the load-demand data packet;
transmitting the adjusted matching coefficient to a transport service system; and
generating, upon receiving a response data packet from the transport service system that is indicative of an acceptance of the adjusted matching coefficient by the carrier entity, a match notification for assigning the load-demand data packet to the load-capacity data packet.

25. The non-transitory computer-readable storage medium of claim 24, wherein the dynamic adjustment factor increases as the carrier metric decreases.

26. The non-transitory computer-readable storage medium of claim 24, wherein the dynamic adjustment factor is determined as a zero value for the carrier metric indicative of a specified size of the carrier entity.

27. The non-transitory computer-readable storage medium of claim 24, wherein the method for determining the dynamic adjustment factor includes:
determining the dynamic adjustment factor based on a carrier type parameter associated with the load-capacity data packet.

28. The non-transitory computer-readable storage medium of claim 24, wherein the method of determining the dynamic adjustment factor includes:
determining the utilization index as an unloaded distance to be traveled by a vehicle for fulfilling the load demand, wherein the unloaded distance is determined based on the load-capacity route and the load-demand route, and
determining the dynamic adjustment factor based on the utilization index.

29. The non-transitory computer-readable storage medium of claim 28, wherein the unloaded distance is determined based on a sum total of the distance between (a) an origin location of the load-capacity route and an origin location of the load-demand route, and (b) a destination location of the load-demand route and a destination location of the load-capacity route.

30. The non-transitory computer-readable storage medium of claim 28, wherein the dynamic adjustment factor decreases as the unloaded distance increases.

31. The non-transitory computer-readable storage medium of claim 24, wherein the method of determining the dynamic adjustment factor includes:
determining the utilization index as time taken to travel an unloaded distance for fulfilling the load demand, wherein the unloaded distance is determined based on the load-capacity route and the load-demand route, and
determining the dynamic adjustment factor based on the utilization index.

32. The non-transitory computer-readable storage medium of claim 31, wherein the time taken to travel the unloaded distance is determined based on a sum total of the time taken to travel from (a) an origin location of the load-capacity route to an origin location of the load-demand route, and from (b) a destination location of the load-demand route to a destination location of the load-capacity route.

33. The non-transitory computer-readable storage medium of claim 31, wherein the dynamic adjustment factor decreases as the time taken to travel the unloaded distance increases.

34. The non-transitory computer-readable storage medium of claim 24, wherein the method of adjusting the matching coefficient includes:
adding the dynamic adjustment factor to the matching coefficient to obtain the adjusted matching coefficient.

35. The non-transitory computer-readable storage medium of claim 24, wherein the method of receiving further includes:
comparing, by the load matching system, the load-demand route with a plurality of load-capacity routes received at the load matching system to determine a matching load-capacity route, and
determining, by the load matching system, the dynamic adjustment factor from the load-capacity data packet with which the matching load-capacity route is associated.

36. The non-transitory computer-readable storage medium of claim 24, wherein the method of generating the match notification includes:
sending the match notification to the transport service system from which the load-capacity data packet is received and to a transportation management system from which the load-demand data packet is received for assigning the load-demand data packet to the load-capacity data packet.

37. A system comprising:
a processor; and
a memory storing instructions that, when executed by the processor, cause the processor to perform a method, the method comprising:
receiving a load-capacity data packet indicating availability of backhaul load capacity in a load-capacity route, and a load-demand data packet indicating a need for load capacity along a load-demand route;
determining a dynamic adjustment factor based on a carrier metric and a utilization index, wherein the carrier metric is indicative of a size of a carrier entity associated with the load-capacity data packet and the utilization index is indicative of a relationship between the load-capacity route and the load-demand route;
using a prediction model generated through machine learning (ML) trained to match a load demand request and available backhaul load capacity, wherein the prediction model considers inferred factors selected from one or more of.
carrier preference data explicitly provided by the carrier entity.
carrier preference data inferred from carrier history in matching a load demand request and available backhaul load capacity, and
statistical models or other analytics models:
incorporating into the load matching system inferred factor criteria comprising one or more of carrier preference data, factors inferred by the prediction model;
finding a matching lane to assign a load demand to an available load capacity of the carrier entity, based on the carrier preference data:
determining matching coefficient for assigning a load demand to the available load capacity on the matching lane;
adjusting a matching coefficient associated with the load-demand data packet based on the dynamic adjustment factor to generate an adjusted matching coefficient, wherein the matching coefficient modifies a load assignment metric, the load assignment metric being a computed value that determines whether the load-demand data packet is assigned to the load-capacity data packet to fulfill a load demand associated with the load-demand data packet;
transmitting the adjusted matching coefficient to a transport service system; and
generating, upon receiving a response data packet from the transport service system that is indicative of an acceptance of the adjusted matching coefficient by the carrier entity, a match notification for assigning the load-demand data packet to the load-capacity data packet.
